(19) United States
(12) Patent Application Publication
(10) Pub. No.: US 2012/0146848 A1
(43) Pub. Date: Jun. 14, 2012

(54) GPS SIGNAL QUALITY UTILIZE POWER REDUCTION

(76) Inventors: Guy EZER, Shoham (IL); Doron Maliach, Kedar (IL)

(21) Appl. No.: 12/963,195

(22) Filed: Dec. 8, 2010

(51) Int. Cl. G01S 19/42; G01S 19/52; G01S 19/34

(52) U.S. Cl. 342/357.25; 342/357.74; 342/357.35

(57) ABSTRACT

According to various embodiments, a method is disclosed that includes determining a speed of a mobile device based on one or more global positioning signals; and controlling a global positioning module of the mobile device based on the determined speed.

This disclosure relates generally to the field of Global Positioning Systems (GPS), and in particular to a method and device arranged to reduce power consumption for GPS systems based on signal quality.

### BACKGROUND

Power consumption for battery-operated mobile device, such as mobile internet devices like cellular phones, laptop, netbooks and tablet computers is an important design consideration. Screen size, screen brightness, wireless adaptors, power-hungry applications, global positioning modules all contribute to the power drain experienced by the mobile device's battery. For example, typically a larger and/or brighter display will require more power to operate. Moreover, devices using GPS typically receive global positioning signals every 1 second even when the device is not moving or moving very slowing such the location of the device has not changed substantially. Selectively deactivating these power-hungry features can help to extend the operating time of the mobile devices.

Given the above problem, an improved power management scheme is need for battery-powered mobile devices.

### BRIEF DESCRIPTION OF THE DRAWINGS

FIG. 1 shows an example mobile device in accordance with aspects of the present disclosure.

FIG. 2 shows an example flow chart for some aspects of the present disclosure.

### DETAILED DESCRIPTION

### Description

In accordance with some aspects of the present disclosure, a method is disclosed that includes determining a speed of a mobile device based on one or more global positioning signals; and controlling a global positioning module of the mobile device based on the determined speed.

In some aspects, the method can decrease power or not decrease power of the global positioning module based on the determined speed being greater than or equal to a predefined speed threshold. The predefined speed threshold can be between 3 and 6 meters/second. Determining the speed can be based on a predefined time threshold, wherein the predefined time threshold can be between 5 and 30 seconds. For example, the mobile device can determine a current speed every 5 to 30 seconds, depending on number of conditions. For example, if the user of the mobile device is walking, the time threshold may be chosen to be longer than if the user is driving in a vehicle. In general the user can choose between maximum power saving or maximum performance/accuracy.

In some aspects, the method can include periodically determining a current speed if the determined speed is greater or equal to the predefined speed threshold, wherein the current speed is determined about every 1 second.

In some aspects, the method can include determining a location of the mobile device based on the determined speed.

In some aspects, the method can include determining a signal quality of the three or more global positioning signals. In the method, the controlling can include providing power to the global positioning module if the determined signal quality is greater than or equal to a predefined signal quality threshold. For example, the predefined signal quality threshold can be −145 db.

In accordance with some aspects of the present disclosure, a method is disclosed that includes determining a location of a mobile device based on three or more global positioning signals; and controlling a global positioning module of the mobile device based on the determined location.

In some aspects, the method can include determining a speed of the mobile device based on the determined location and providing power to the global positioning module based on the determined speed being greater than or equal to a predefined speed threshold. The predefined speed threshold can be between 3 and 6 meters/second. Determining the speed can be based on a predefined time threshold, wherein the predefined time threshold can be between 5 and 30 seconds.

In some aspects, the method can include periodically determining a current speed and/or location if the determined speed is greater or equal to the predefined speed threshold, wherein the current speed is determined about every 1 second.

In some aspects, the controlling can include providing power to the global positioning module if the determined location is different than or the same as a predefined location threshold, wherein the predefined location threshold can be between 5 and 50 meters in radius from a current location of the mobile device. For example, while in power save mode the mobile device can determine a current speed every 5 to 30 seconds, depending on number of conditions. For example, if the user of the mobile device is walking, the distance or location threshold may be chosen to be smaller than if the user is driving in a vehicle.

In accordance with some aspect of the present disclosure, a device is disclosed that includes a mobile device including a global positioning module, the global position module configured to determine a speed of a mobile device based on three or more global positioning signals and determine a signal quality of the one or more global positioning signals, wherein the mobile device is configured to provide power to the global positioning module if the determined speed is greater than or equal to a predefined speed threshold.

In some aspects, the predefined speed threshold can be between 3 and 6 meters/second and the determining of the speed is based on a predefined time threshold, for example, the predefined time threshold can be between 5 and 30 seconds.

In some aspects, the mobile device can be configured to provide power to the global positioning module if the determined signal quality is greater than or equal to a predefined signal quality threshold. For example, the predefined signal quality threshold can be −145 db.

In the following detailed description, numerous specific details are set forth in order to provide a thorough understanding of the disclosure. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present disclosure may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachings of the disclosure as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

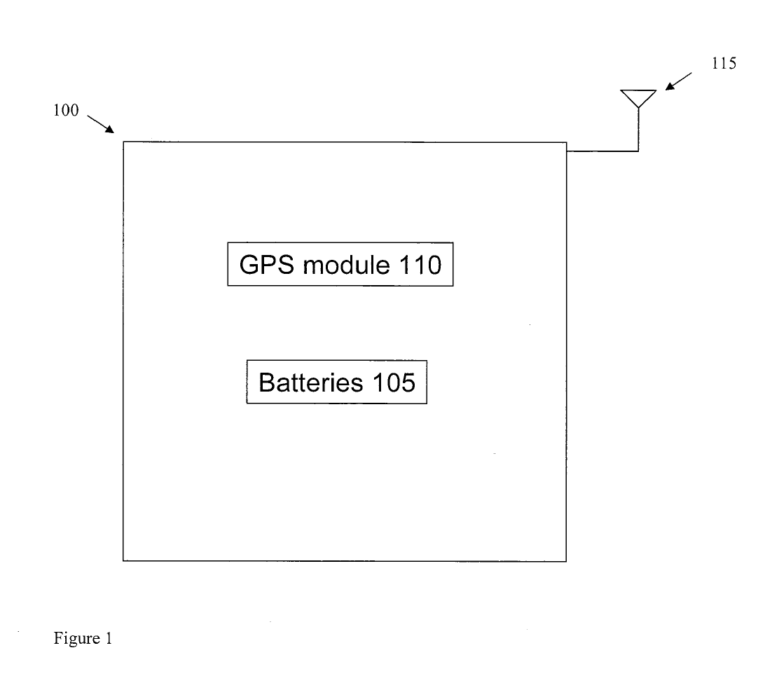

FIG. 1 shows an example mobile device in accordance with aspects of the present disclosure. Mobile device 100 can be a mobile internet device, for example a battery-operated mobile or hand-held computer such as a cellular phone, internet appliance, laptop computer, netbook, table computer. Mobile device 100 includes one or more batteries 105 that are used to power the mobile device. A GPS module 110 is configured with transceiver 115 to send and/or receive location signals, such as GPS signals. GPS module 110 can be configured to determine a velocity and/or a location of mobile device 100.

If GPS module 110 determines that mobile device 100 has not changed location substantially since the last location was determined or that the speed is lower than a predefined speed threshold, GPS module 110 powers down for a predetermined time interval. The current location can be compared with a previous location to determine if GPS module 110 should be provided power. If the location is within a predefined location threshold, for example within 5-50 meters in radius of the previous location, GPS module remains powered off. The predefined location threshold can be customized by the user based on the user's preference. For example, if the user is walking, then the predefined location threshold can be set to a larger radius than if the user is traveling by vehicle.

If the GPS module 110 determines that mobile device is traveling below a predefined speed threshold, GPS module 110 can be powered down. For example, if the speed is determined to below 3-6 meters/second, then it is not necessary for GPS module 110 to determine the current location of mobile device 110 since it will not have moved substantially far. The predefined speed threshold can be customized by the user based on the user's preference. For example, if the user is walking, then the predefined speed threshold can be set to a smaller speed than if the user is traveling by vehicle.

GPS module 110 can also determine a signal quality of the location signals received at transceiver 115. If the signal quality is below a signal quality threshold, then GPS module 110 need not consume additional battery resources if it is unlikely to acquire an adequate GPS signals. For example, the signal quality threshold can be set by the user such that any signal below, for example, −145 db would signal GPS module 110 not to power down in order to save power.

GPS module 110 can be programmed to acquire a new current location or determine a current speed of mobile device 100 according to a predefined time interval. For example, GPS module 100 can be powered up every 5 to 30 seconds, depending on user selection. For example, if the user is traveling by vehicle, GPS module 110 can be programmed to awaken at a smaller time interval, for example every 5 seconds, to determine a new location or determine a current speed. Once GPS module 110 determines that the location is changing or the speed is greater than the predetermined speed threshold, GPS module 110 can be programmed to acquire location signals, determine a new location and/or determine a current speed every 1 second, for example.

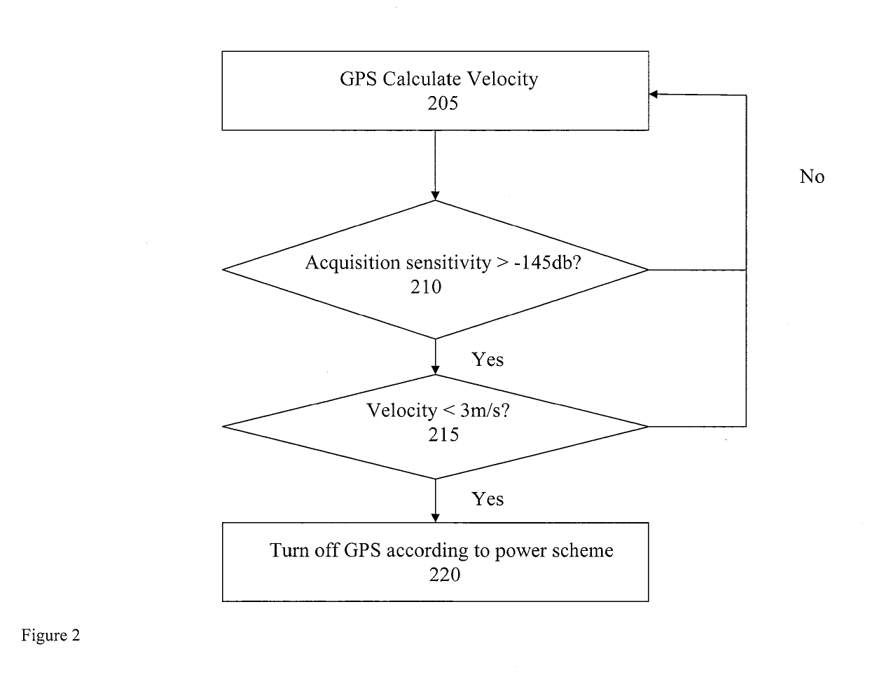

FIG. 2 shows an example flow chart for some aspects of the present disclosure. At 205, the GPS module calculates velocity. A determination is made at 210 as to whether the acquisition sensitivity is above a predetermined sensitivity threshold. For example, the predetermined sensitivity threshold is −145 db. If the result of the determination at 210, is yes, then the process proceeds to 215 where a determination is made as to whether the velocity is below a predetermined speed. For example, the predetermined speed is 2 m/s. If the result of the determination at 215 is yes, then the process proceeds to 220 where the GPS module is powered off according to a predefined power management scheme. The process then loops back to 105, where the velocity is again determined by the GPS module. If the result of the determination at either 210 or 215 is no, then the process loops back to 205.

In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

Various embodiments herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed:

1. A method comprising:
determining a speed of a mobile device based on one or more global positioning signals; and
controlling a global positioning module of the mobile device based on the determined speed.

2. The method according to claim 1, wherein the controlling includes providing power to the global positioning module if the determined speed is greater than or equal to a predefined speed threshold.

3. The method according to claim 1, wherein the controlling includes not providing power to the global positioning module if the determined speed is less than or equal to a predefined speed threshold.

4. The method according to claim 2, wherein the predefined speed threshold is between 3 and 6 meters/second.

5. The method according to claim 3, wherein the predefined speed threshold is between 3 and 6 meters/second.

6. The method according to claim 1, wherein the determining the speed is based on a predefined time threshold.

7. The method according to claim 6, wherein the predefined time threshold is between 5 and 30 seconds.

8. The method according to claim 2, further comprising periodically determining a current speed if the determined speed is greater or equal to the predefined speed threshold.

9. The method according to claim 8, wherein the current speed is determined about every 1 second.

10. The method according to claim 1, further comprising determining a location of the mobile device based on the determined speed.

11. The method according to claim 1, further comprising determining a signal quality of the one or more global positioning signals.

12. The method according to claim 11, wherein the controlling includes providing power to the global positioning module if the determined signal quality is greater than or equal to a predefined signal quality threshold.

13. A method comprising:
determining a location of a mobile device based on one or more global positioning signals; and
controlling a global positioning module of the mobile device based on the determined location.

14. The method according to claim 13, wherein the controlling includes providing power to the global positioning module if the determined location is different than or the same as a predefined location threshold.

15. The method according to claim 14, wherein the predefined location threshold is between 5 and 50 meters in radius from a current location of the mobile device.

16. A device comprising:
a mobile device including a global positioning module, the global position module configured to determine a speed of a mobile device based on one or more global positioning signals and determine a signal quality of the one or more global positioning signals, wherein the mobile device is configured to provide power to the global positioning module if the determined speed is greater than or equal to a predefined speed threshold.

17. The device according to claim 16, wherein the predefined speed threshold is between 3 and 6 meters/second.

18. The device according to claim 17, wherein the determining the speed is based on a predefined time threshold.

19. The device according to claim 18, wherein the predefined time threshold is between 5 and 30 seconds.

20. The device according to claim 16, wherein the mobile device is configured to provide power to the global positioning module if the determined signal quality is greater than or equal to a predefined signal quality threshold.
